(19) United States
(12) Patent Application Publication
(10) Pub. No.: US 2010/0096405 A1
(43) Pub. Date: Apr. 22, 2010

(54) PIPETTING DEVICE

(75) Inventor: ROBERT HECHT, Frieburg (DE)

Correspondence Address: Townsend and Townsend and Crew LLP, Two Embarcadero Center, 8th Floor, San Francisco, CA, 94111, US

(73) Assignee: Beckman Coulter, Inc., Brea, CA (US)

(21) Appl. No.: 12/643,103

(22) Filed: Dec. 21, 2009

Related U.S. Application Data
(63) Continuation of application No. 11/577,166, filed on Apr. 12, 2007.

(30) Foreign Application Priority Data
Oct. 16, 2004 (DE) 1020004050466.0

(51) Int. Cl. G01F 11/10; B01L 3/02

(52) U.S. Cl. 222/1; 422/100

(57) ABSTRACT

A pipetting system including a pipet (8) which can be hooked up to pressurizing source (9), the pipet being fitted with a discharge aperture (10) and having an inside volume sufficient to receive the full quantity of liquid (7) to be discharged is characterized in that the discharge aperture (10) is situated at one end part (16) of the pipet (8), the end part being connectable to a connector aperture (19) of a main part (15) of the pipet, the main part receiving all the liquid (7) that shall be discharged, the connector part aperture (19) being larger than the discharge aperture (10).

### CROSS-REFERENCES TO RELATED APPLICATIONS

This application is a continuation of U.S. application Ser. No. 11/577,166, filed Apr. 12, 2007, which is a U.S. National Stage of PCT/EP2005/010666, filed Oct. 4, 2005, which claims priority to German Patent Application No. 102004050466.0 filed on Oct. 16, 2004, the entire contents of which are incorporated herein by reference.

### BACKGROUND OF THE INVENTION

Pipet systems are frequently required in very fine metering designs demanding exceedingly narrow pipet discharge apertures. Illustratively, such systems are needed to pipet tiny amounts of liquid in free fall into a reagent glass or also to deposit tiny amounts of liquid on carrier plates to carry out chemical, in particular biochemical reactions, or for instance also when microscopying.

A further example are the means depositing inoculating solutions on nutrient media. They are used, for instance, to detect germs such as bacteria or fungi contained in the inoculating solution by means of incubation multiplication. This requires depositing at a given thickness the inoculating solution onto the surface of a nutrient medium, typically in a Petri dish. The pipet discharge aperture then must be very narrow.

U.S. Pat. No. 5,294,325 A in its FIG. 1 discloses a pipet system wherein a pipet designed as an injection needle may be connected to a pressurizing element designed as a plunger syringe. Such a design incurs the drawback that both the pipet and the pressurizing element must be discarded when dispensing contaminated substances which must be precluded from being carried from one sample to the next.

In generic systems employed in the present state of the art, the pipet collects the full amount of the liquid which must be dispensed to prevent the liquid from making contact with the pressurizing element. As a result, the pipet may be designed as a disposable item whereas the uncontaminated pressurizing element can be re-used.

Known systems of the above kind comprise an integral pipet. Such pipets are filled conventionally by aspiration, entailing a very long time due to the narrow discharge aperture. In serial testing requiring filling the pipets very quickly, this feature is a significant drawback.

Accordingly it is the object of the present invention to create a system of the above kind allowing higher processing rates.

### BRIEF SUMMARY OF THE INVENTION

According to the present invention, a pipet end part having a discharge aperture can be hooked up to a connector aperture of a main part of the pipet. When hooked up, the pipet may be operated conventionally when depositing a liquid. When disconnected, the main part of the pipet can be filled very rapidly by conventional aspiration through the much larger connector aperture. Accordingly the operational rate can be raised very substantially, especially in serial testing.

The design of the connector may be conventional, for instance using a screw connection or the like. Conical plug-in connectors allow using in this field a widely conventional, simple and accurate connection means.

The pipet end part may be of a rigid, conventional design. Advantageously, however, this end part shall be elongated and flexurally elastic. In this manner the end part may gently lie against the surface of a nutrient medium, its flexibility compensating any damage or change in spacing. This feature is especially advantageous as regards systems moving the pipet relative to the nutrient medium surface when liquid deposition is along lines. Higher accuracy of deposition is attained, and there is less risk of damaging the nutrient medium surface.

An elastically flexuring end part may be conically tapering as is conventional with pipets. Using a hose element as the end part allows especially simple manufacture allowing the accurate selection of the elasticity parameters and the discharge aperture size.

The present invention is shown in the appended drawings in illustrative and schematic manner.

### BRIEF DESCRIPTION OF THE DRAWINGS

FIG. 1 is a top view of the system of the present invention together with nutrient medium and pipet,

FIG. 2 is a section along line 2-2 of FIG. 1,

FIG. 3 is a side view of a pipet rack together with the main pipet components before the pipets are removed,

FIG. 4 is the side view of a removed, main pipet part being filled,

FIG. 5 is the side view of a rack with pipet end parts, and

FIG. 6 is the side view of a complete supported pipet.

### DETAILED DESCRIPTION OF THE INVENTION

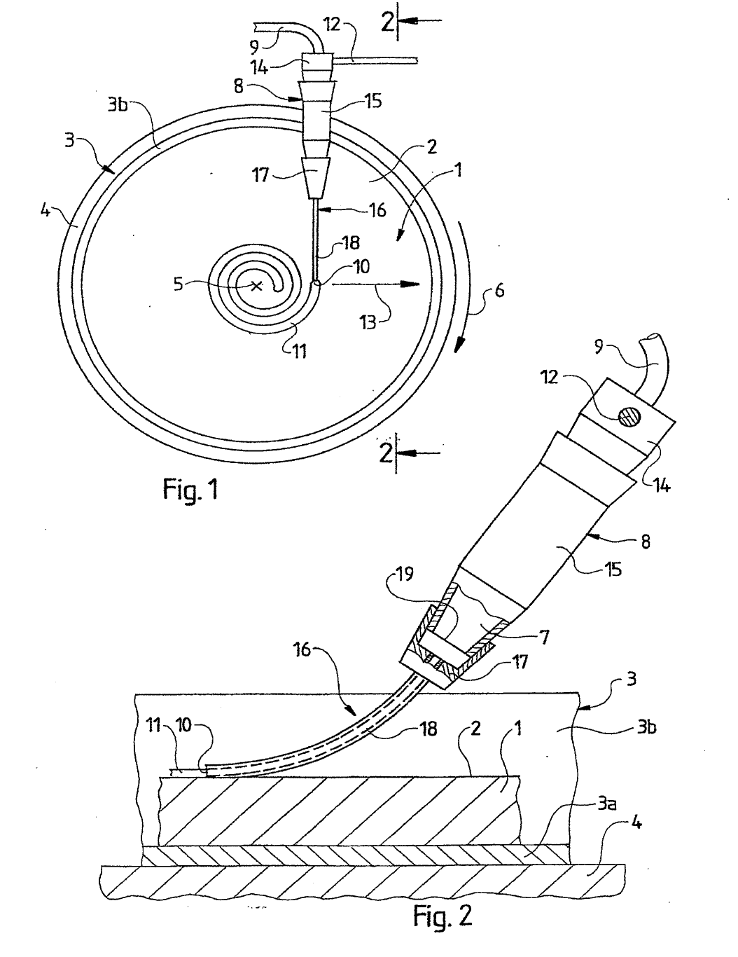

FIGS. 1 and 2 show a system of the invention used to deposit a inoculating solution on the surface 2 of a nutrient medium 1 configured on the base 3a of a Petri dish 3 consisting of its base 3a and a circumferential rim 3b. Such a Petri dish 3 is conventionally also fitted with a cover sealed in a germ-free manner during the ensuing incubation.

The Petri dish 3 rests by its base 3a on a turntable 4 of a drive means, not shown in further detail, whereby the Petri dish 3 and the nutrient medium 1 may be rotated about a vertical axis 5 in the direction of the arrow 6.

Inoculating solution 7 held in readiness in a pipet 8 shall be deposited on the surface 2 of a nutrient medium 1. At one of its ends, pipet 8 is pressurized with compressed air, for instance through a hookup tube 9, and by its other end it expels the inoculating solution 7 through a narrow discharge aperture 10 in form of a line 11 on the surface 2 of the nutrient medium 1.

In the process, the pipet 8 is held in place by a support arm 12 that is displaced and adjusted by an omitted drive means in a manner that it keeps the pipet 8 at a defined height above the surface 2 of the nutrient medium 1 and moves the discharge aperture 10 radially outward in the direction of the arrow 13 during the rotation of the nutrient medium 1. The line 11 of inoculating solution deposited on the surface 2 of the nutrient medium 1 therefore forms a spiral line as indicated in FIG. 1.

The hookup tube 9 is connected to an omitted source of compressed air, assuring expulsion of the inoculating solution 7. Said expulsion may be controlled in variable manner for instance by forming the line 11 from one end to the other at a monotonely decreasing deposition rate in order to dilute the deposited germ concentration.

Instead of the design shown in FIG. 1 comprising the system with a rotational drive for the nutrient medium 1 and linear advance of the pipet 8, this pipet also may be displaced spirally across the nutrient medium 1 at rest or other shapes of the line 11 such as several parallel straight lines may be selected.

The pipet 8 is fitted with a support 14 engaged by the supporting arm 12 and the hookup tube 9. This support 14 also may be designed as a pump pressurizing the pipet 8, in which case the hookup tube 9 would be replaced by electric control lines controlling pumping.

The pipet 8 shown in FIGS. 1 and 2 substantially consists of a main part 15 of which the considerable inside volume may receive all the quantity of inoculating solution 7 to be deposited. In the shown embodiment mode, the main part 15 can communicate by means of a conventional conical plug-in connector with the support 14.

At the end opposite the support 14, the main part 15 also can communicate by means of a conventional conical plug-in connector to a terminal part 16 consisting of a connector part 17 and a hose element 18.

The connector part 17 allows hooking up the end part to the main part 15, said main part 15 comprising a connector aperture 19 which is substantially larger than the very narrow discharge aperture 10 at the end of the end part 16.

In an alternative but omitted design, the end part 16 of the pipet 8 also may assume the conventional pointed, conical shape while however being flexurally elastic in a manner illustratively selecting the thickness of the material or the kind of material. Moreover said end part also may be integral with the main part 15.

Because of the flexurally elastic design of the end part 16, implemented in this case by the thinness of the hose element 18, the pipet 8 may be moved into the position of FIG. 2 while its height is appropriately controlled using the support arm 12. In the process, the hose element 18 rests in an elastic arc on the surface 2 of the nutrient medium 1, whereby the end zone of the hose element 18 is parallel to the surface of the nutrient medium 1.

As shown by FIG. 2, a highly defined position of the discharge aperture 10 is attained in this manner relative to the surface of the nutrient medium 1. If during pipet operation there should be deviations in height for instance caused by inaccurate displacements of the support arm 12 or also by varying thickness of the nutrient medium 1, then said deviations shall be elastically compensated by the flexure of the elastic hose element 18 without the position of the discharge aperture 10 changing relative to the surface of the nutrient medium 1.

Even at high speeds of the pipet 8 across the surface of the nutrient medium 1, the present design precludes fluctuations in deposition, and damages to the delicate surface of the nutrient medium 1.

In the shown embodiment, the end part 16 is detachable from the main part 15 of the pipet 8, namely, the embodiment as shown, by means of a conical connector which also may be replaced by other kinds of connectors.

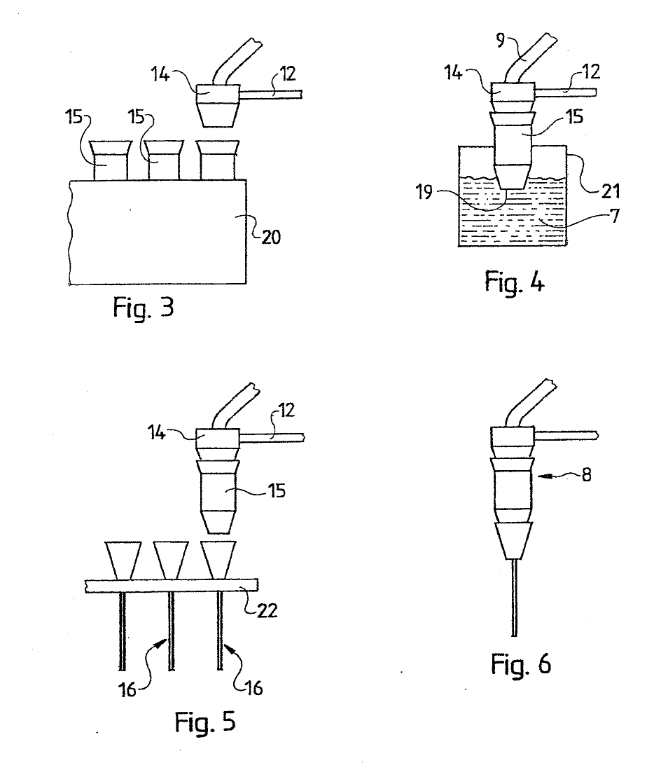

For serial tests, where numerous inoculating solutions must be deposited on numerous nutrient mediums, a rack 20 shown in FIG. 3 may be used, that receives several empty main parts 15. The support 14 of the pipet 18 can be moved in position by means of the support arm 12 above the particular next main part 15 in the rack 20 and then be lowered to be connected to it.

Thereupon, by appropriately displacing the support arm 12, the support 14 together with the main part 15 which is connected to said main part and still empty, as shown in FIG. 4, may be moved above a test vial 21 containing the next inoculating solution 7 to be processed then be lowered until the connector aperture 19 of the main part 15 dips into said solution. The main part 15 then will fill up by a corresponding partial vacuum being applied through the hookup tube 9.

In the next step, shown in FIG. 5, the filled main part 15 is displaced by a commensurate displacement of the support arm 12 above a rack 22 containing a stock of end parts 16 and is connected to one of them. Then, the support arm 12 is raised again. The pipet 8, which now is fully plugged together and filled with liquid, is moved into position as shown in FIG. 6 where, by appropriate control of height and angle, it can be moved above a Petri dish 3 with a nutrient medium 1 in the processing position shown in FIGS. 1 and 2.

In the shown embodiment mode, the pipet 8 is used in a system elucidated in relation to FIGS. 1 and 2 and serving to deposit a inoculating solution on the surface 2 of a nutrient medium 1. However the pipet 8 shown in FIG. 6 also may be used for other purposes.

Illustratively, the pipet 8 may be used to pipet minute amounts of liquid into reaction vials, for instance into microtitration trays. Moreover, said pipet may be used to deposit small amounts of liquid on carrier plates, namely the so-called spots for subsequent biochemical reactions. It also may be used to deposit small quantities of liquid on object supports for purposes of microscopying. Further applications are feasible wherein minute quantities of liquid must be pipeted and high processing speeds are required.

None of such applications requires that the pipet tip as shown in the Figures be fitted with a long and thin end part 16. The pipet tip also may be short provided that the discharge aperture 10 is very narrow.

What is claimed is:

1 A pipetting method for quickly filling a pipet , used for depositing small quantities of liquid with a liquid and subsequently discharging the liquid through a narrow discharge aperture, the method comprising the steps of:
providing a support;
providing an end part with a very narrow discharge aperture;
providing an empty main part designed to receive the full quantity of the liquid to be discharged. the main part comprising a connector aperture which is substantially larger than the very narrow discharge aperture of the end part; connecting the empty main part to the support by means of a first connector;
filling the empty inside volume of the main part by aspiration of said full quantity of liquid to be dispensed, through the connector aperture by applying a corresponding partial vacuum;
subsequently connecting the filled main part to the end part to the connector aperture; and
subsequently discharging said full quantity of liquid that was added prior to connection of the end part from the pipet through the very narrow discharge aperture of the end part by pressurizing the pipet.

2. The pipetting method as claimed in claim 1, wherein the end part further comprises a conical connection part that is connectable to the connector aperture of the main part.

3. The pipetting method as claimed in claim 2, wherein the end part is elongated, flexurally elastic, its discharge aperture being situated at one of its ends and the connection part at the other.

4. The pipetting method as claimed in claim 1, wherein the end part comprises a connector part to which is affixed a hose element fitted at its free end with said discharge aperture.

5. A pipetting device, for depositing small quantities of liquid comprising a pipet fitted with a support,
wherein the support may be connected to a pressurizing unit,
wherein the pipet comprises a main part and an end part,
wherein the main part is connected to the support by means of a first connector,
wherein the end part is connected to the main part by means of a second connector,
wherein the end part is fitted with a very narrow discharge aperture,
wherein the main part comprises a connector aperture which is substantially larger than the very narrow discharge aperture of the end part, and
wherein the inside volume of the main part is designed to receive the full quantity of liquid to be discharged.

6. The pipetting device as claimed in claim 5, wherein the second connector is a conical connection part.

7. The pipetting device as claimed in claim 5, wherein the end part is elongated, flexurally elastic, its discharge aperture being situated at one of its ends and the hook up device at the other.

8. The pipetting device of claim 7, wherein the end part comprises a hooked up zone to which is affixed a hose element fitted at its free end with said discharge aperture (10).

9. A pipetting device for deposition of an inoculating solution on a surface of a nutrient medium, the device comprising
a pipette comprising an elongated, flexurally elastic end part having an end region and a discharge aperture; and
the nutrient medium;
wherein the pipette is held in a deposition position with respect to the surface of the nutrient medium such that the end part rests in an elastic arc on the surface of the nutrient medium;
and wherein the nutrient medium and the pipette are movable relative to each other in the direction of the surface of the nutrient medium.

10. The pipetting device of claim 9, wherein the distance between the pipette and the surface of the nutrient medium is such that the end region of end part is parallel to the surface.

11. The pipetting device of claim 9, wherein the end part is a hose element.

12. The pipetting device of claim 9, wherein the end part is attached to the pipette by a conical connection part which has an aperture that is larger than the discharge aperture.

13. The pipetting device of claim 9, wherein the nutrient medium is positioned on a turntable having a drive means whereby the nutrient medium is rotated about the vertical axis of the turntable.
